(19) United States
(12) Patent Application Publication
(10) Pub. No.: US 2007/0027918 A1
(43) Pub. Date: Feb. 1, 2007

(54) Mail processing server, mail processing method, and mail processing program

(75) Inventors: Nobuo Kawakami, Tokyo (JP); Masato Horinouchi, Tokyo (JP); Kazuo Hayakawa, Tokyo (JP)

Correspondence Address: GREENBLUM & BERNSTEIN, P.L.C., 1950 ROLAND CLARKE PLACE, RESTON, VA, 20191, US

(73) Assignee: Dwango Co., Ltd., Tokyo (JP)

(21) Appl. No.: 11/239,090

(22) Filed: Sep. 30, 2005

(30) Foreign Application Priority Data
Jul. 29, 2005 (JP) 2005-221843
Sep. 27, 2005 (JP) 2005-280642

(51) Int. Cl. G06F 17/00

(52) U.S. Cl. 707/104.1

(57) ABSTRACT

There are provided a mail processing server, a mail processing method, and a mail processing program, which can more efficiently utilize server resources and construct a system at low cost. First, desired information is retrieved from any one of a dictionary DB, a story DB, and a game contents DB of a database in which information on information retrieval request is registered on the basis of state information corresponding to a current information retrieval request from a mobile phone. Then, a mail in which retrieval result information and state information relating to the retrieval result information are described is transmitted to the mobile phone. In response to a reply mail from the mobile phone, next information retrieval is executed based on the state information described in the reply mail.

The present disclosure relates to subject matter contained in Japanese Patent Application No. 2005-221843, filed on Jul. 29, 2005, and Japanese Patent Application No. 2005-280642, filed on Sep. 27, 2005, the disclosures of which are expressly incorporated herein by reference in their entirety.

### BACKGROUND OF THE INVENTION

1. Field of the Invention

The present invention relates to a mail processing server, a mail processing method, and a mail processing program, in which information requested by the use of a mail function of a mobile terminal such as a mobile phone can be retrieved and the retrieved information can be delivered to the mobile terminal.

2. Description of the Related Art

When it is intended to retrieve desired information through the use of Internet, there is known a method of logging in an information retrieval site and inputting a retrieval keyword to a screen for inputting a retrieval keyword. Such information retrieval can have been executed in a mobile terminal such as mobile phone as well as in a personal computer.

However, even when the mobile terminal such as a mobile phone has a browser function, a display speed is small due to restriction on its communication speed or the like and much time is required for obtaining the desired information. In addition, since a screen for inputting a keyword for retrieving information should be displayed, its packet communication cost is required.

In Japanese published Unexamined Patent Application Publication No. 1999-39328, in order to retrieve desired information, there is disclosed an information retrieval method that communications between an agent client and an agent server are carried out by the use of an E-mail through a mail server and when the agent server receives a retrieval request mail in the form of E-mail from the agent client, the agent server accesses a WWW server based on the retrieval request mail, retrieves the desired information, and transmits its retrieval result and estimation as a retrieval result notifying mail in the form of E-mail to the agent client.

In this way, in the above-mentioned Japanese published Unexamined Patent Application, since the agent server carries out the transmission and reception of the retrieval request and result via the mail server, it is not necessary for the client to access the network in the course of performing the retrieval. Accordingly, it is thought out that the time for accessing a network server can be reduced and the communication cost thereof can be reduced.

On the other hand, in the above-mentioned Japanese Unexamined Patent Application Publication, when the agent server receives the information retrieval request in the form of E-mail from the agent client, the agent server accesses the WWW server in response to the information retrieval request to retrieve the desired information. Accordingly, it is necessary to retain state information indicating the state of the information retrieval request from a user in the server.

In this case, with increase in the number of users enjoying information retrieval services, the state information indicating the state of the information retrieval request from the users should be retained in a dedicated database or files of the server in mass. Therefore, there are problems that server resources should be prepared to correspond to the number of users and that the cost for constructing a system increases.

### SUMMARY OF THE INVENTION

An advantage of the present invention is to provide a mail processing server, a mail processing method, and a mail processing program, which can more efficiently utilize server resources and construct a system at low cost.

According to an aspect of the invention, there is provided a mail processing server for transmitting to and receiving from a client a mail, the mail processing server including: a memory unit for storing the received mail from the client; a keyword extracting unit for extracting keywords from the received mail stored in the memory unit; an execution unit for interpreting a query based on the keywords extracted by the keyword extracting unit and executing a process corresponding to the query; a reply mail generating unit for inserting the query to the title of a reply mail and generating a text of the reply mail by the use of the execution result of the execution unit; and a mail replying unit for replying the reply mail generated by the reply mail generating unit to the client which serves as a transmission source.

In this case, the execution unit may execute a dictionary search and may acquire a meaning of a term as the execution result.

The execution unit may execute a game processing and may acquire a selected branch for proceeding with a game as the execution result.

In this case, the execution unit may check existence of a return symbol in the keyword corresponding to the title of the received mail among the keywords extracted by the keyword extracting unit and may execute the process corresponding to the query by using the return symbol as an index when it is checked that the return symbol exists.

In addition, the return symbol may include a numeral and may indicate a different index corresponding to the numeral.

According to another aspect of the invention, there is provided a mail processing method of a server that transmits to and receives from a client a mail, the method including: storing a received mail from the client in a memory provided in the server; extracting keywords from the received mail stored in the memory; interpreting a query based on the keywords extracted and executing a process corresponding to the query; inserting the query to the title of a reply mail and generating a text of the reply mail by the use of the execution result; and replying the reply mail generated to the client which is a transmission source.

In this case, the executing of the process may include executing a dictionary search and acquiring a meaning of a term as the execution result.

The executing of the process may include executing a game processing and acquiring a selected branch for proceeding with a game as the execution result.

The executing of the process may include checking existence of a return symbol in the keyword corresponding to the title of the received mail among the keywords extracted by the keyword extracting means and executing the process corresponding to the query by using the return symbol as an index when it is checked that the return symbol exists

According to still another aspect of the invention, there is provided a mail processing program which can be executed in a computer of a server that transmits to and receives from a client a mail, the mail processing program allowing the computer to execute: storing a received mail from the client in a memory provided in the server; extracting keywords from the received mail stored in the memory; interpreting a query based on the keywords extracted and executing a process corresponding to the query; inserting the query to the title of a reply mail and generating a text of the reply mail by the use of the execution result; and replying the reply mail generated to the client which is a transmission source.

In this case, the executing of the process may include executing a dictionary search and acquiring a meaning of a term as the execution result.

The executing of the process may include executing a game processing and acquiring a selected branch for proceeding with a game as the execution result.

The executing of the process may include checking existence of a return symbol in the keyword corresponding to the title of the received mail among the keywords extracted by the keyword extracting means and executing the process corresponding to the query by using the return symbol as an index when it is checked that the return symbol exists.

The above as well as additional objects, features, and advantages of the present invention will become apparent in the following detailed written description.

### BRIEF DESCRIPTION OF THE DRAWINGS

The invention will be described with reference to the accompanying drawings, wherein like numbers reference like elements and wherein:

FIG. 1 shows an example of a system including a mail processing server according to the present invention;

FIG. 2 is a block diagram illustrating a detailed configuration of the mail processing server shown in FIG. 1;

FIG. 3 is a diagram illustrating a keyword extracting table shown in FIG. 2;

FIG. 4 is a flow chart illustrating an information delivering method in the mail processing server shown in FIG. 1;

FIGS. 5A and 5B are diagrams illustrating the information delivering method in the mail processing server shown in FIG. 1;

FIG. 6 is a flow chart illustrating in detail a step S2 shown in FIG. 4;

FIG. 7 is a diagram illustrating the change of a screen of a mobile phone accompanied with the information retrieval and delivery from a dictionary DB shown in FIG. 1;

FIG. 8 is a diagram illustrating the change of a screen of a mobile phone accompanied with the information retrieval and delivery from a story DB shown in FIG. 1; and

FIG. 9 is a diagram illustrating the change of a screen of a mobile phone accompanied with the information retrieval and delivery from a game contents DB shown in FIG. 1.

### DESCRIPTION OF THE EMBODIMENTS

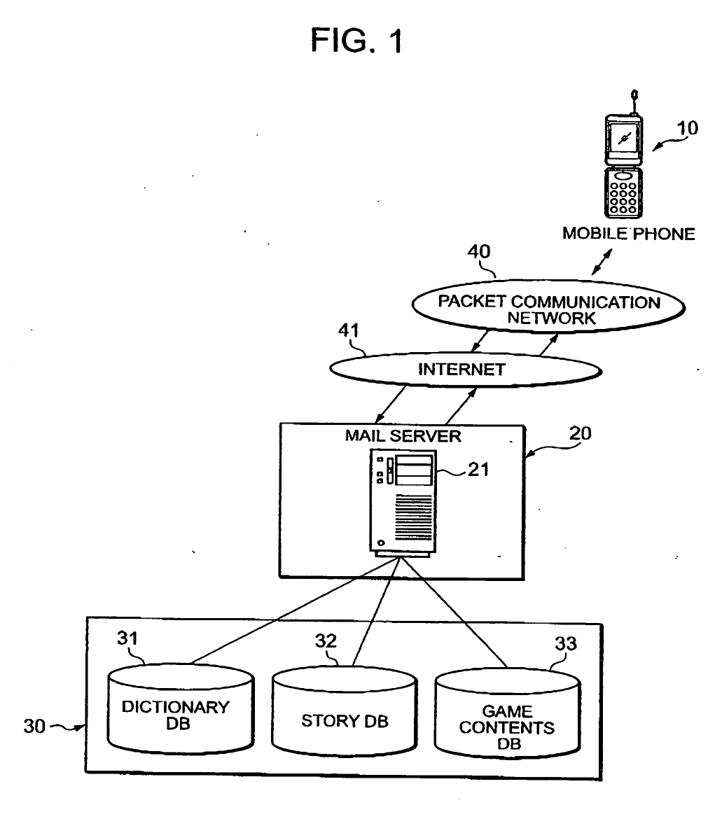

FIG. 1 shows an example of a system including a mail processing server according to the present invention. State information described in the following description can be used for delivering stateless information That is, “stateless” mentioned here means that no pre-processing or after-processing is necessary for a series of processes of transmitting some request or intention and that it is not necessary to always retain a “state” of a user.

An information delivery system shown in FIG. 1 includes a mobile phone 10, a mail server 20, and a database 30.

A client (i.e., The mobile phone 10) is a mobile terminal which can communicate with the mail server 20 through the use of packet communication networks 40 of communication carriers and the Internet 41 as a communication line. At least a mail function is provided to the mobile phone 10. The client is not limited to the mobile phone 10, but may be another apparatus such as PDA.

The mail server 20 as a mail processing server is designed to retrieve the corresponding information from the database 30 in response to an information retrieval request in the form of E-mail from a user with the mobile phone 10 and to reply the corresponding information to the mobile phone 10 of the user.

The mail server 20 is designed to check the current state, for example, by inputting the state of a user to the title of the mail in response to a mail from the mobile phone 10. Details of the mail server will be described later.

The database 30 has, for example, a dictionary DB 31, a story DB 32, and a game contents DB 33. Information such as details of terms is registered in the dictionary DB 31. A variety of story information is registered in the story DB 32. A variety of game information is registered in the game contents DB 33.

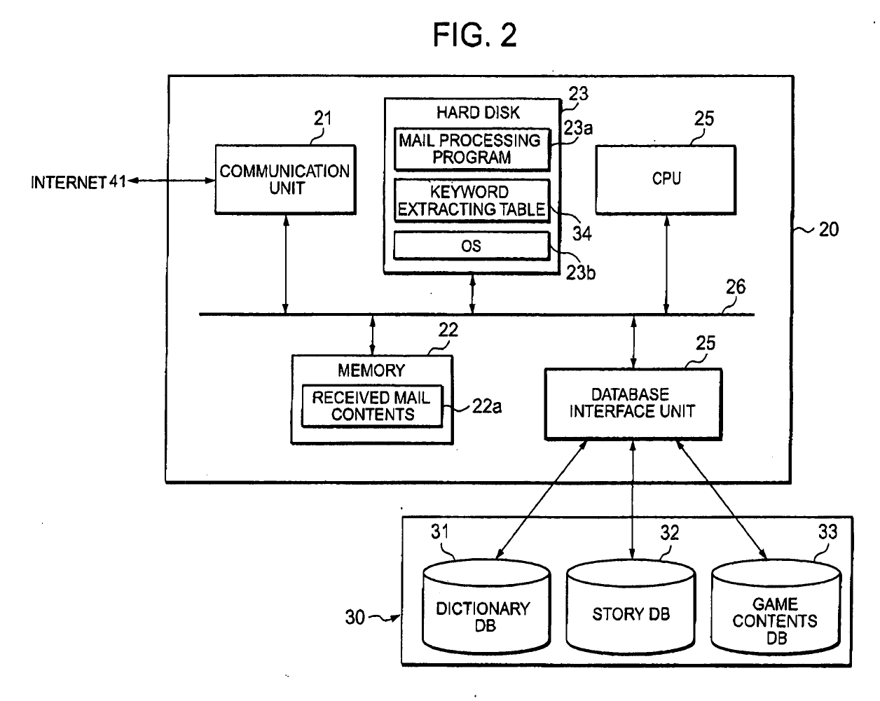

FIG. 2 is a diagram illustrating details of the mail server 20. The mail server 20 has a communication unit 21, a memory 22, a hard disk 23, a database interface unit 24, and a CPU 25.

The communication unit 21 performs a packet communication with the mobile phone 10 through the use of the Internet 41. The memory 22 as a memory unit temporarily stores a received mail 22a from the mobile phone 10. The hard disk 23 stores a mail processing program 23a which is the present invention, a keyword extracting table 34, and an operating system (OS) 23b. The database interface unit 24 is connected to the database 30 such as the dictionary DB 31, the story DB 32, and the game contents DB 33 and gives and takes data with the respective databases. The CPU 25 controls the aforementioned hardware. All the hardware is connected to each other through a bus 26.

The keyword extracting unit is embodied by allowing the mail processing program 23a read out from the hard disk 23 under the control of the CPU 25 to operate with reference to the keyword extracting table 34. The keyword extracting unit reads out the state information and extracts the keywords from the received mail 22a temporarily stored in the memory 22 as a memory unit.

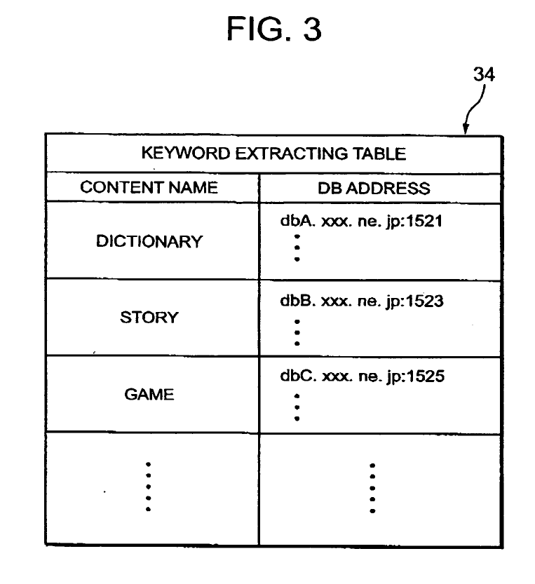

Now, details of the keyword extracting table 34 are described with reference to FIG. 3 A plurality of keywords such as “dictionary”, “story”, and “game” are registered as content names Addresses such as “dbA.xxx.ne.jp:1521”, “dbB.xxx.ne.jp.1523”, and “dbC.xxx.ne.jp.1525” are registered as addresses of the database corresponding to the contents.

The case that the mail processing program 23a refers to the keyword extracting table 34 has been described in the embodiment, but the present invention is not limited to the case. For example, the information on the content names and the addresses of the database may be included in the mail processing program 23a and the keyword extracting unit may be embodied without reference of the mail processing program 23a to the keyword extracting table 34.

The description is replied to FIG. 2. The execution unit is embodied by allowing the mail processing program 23a, which has been read out from the hard disk 23 to cooperate with the database interface unit 24 under the control of the CPU 25. The execution unit serves to estimate a query based on the keywords extracted by the keyword extracting unit and to retrieve desired information from any one of the dictionary DB 31, the story DB 32, and the game contents DB 33 of the database 30.

A reply mail generating unit is embodied by the mail processing program 23a which has been read out from the hard disk 23 under the control of the CPU 25. The reply mail generating unit serves to add the state information including the query to the title of the reply mail and to generate the text of the reply mail by the use of the execution result of the execution unit.

A mail replying unit is embodied by allowing the mail processing program 23a, which has been read out from the hard disk 23, to cooperate with the communication unit 21 under the control of the CPU 25. The mail replying unit serves to reply the reply mail to the client as a transmission source.

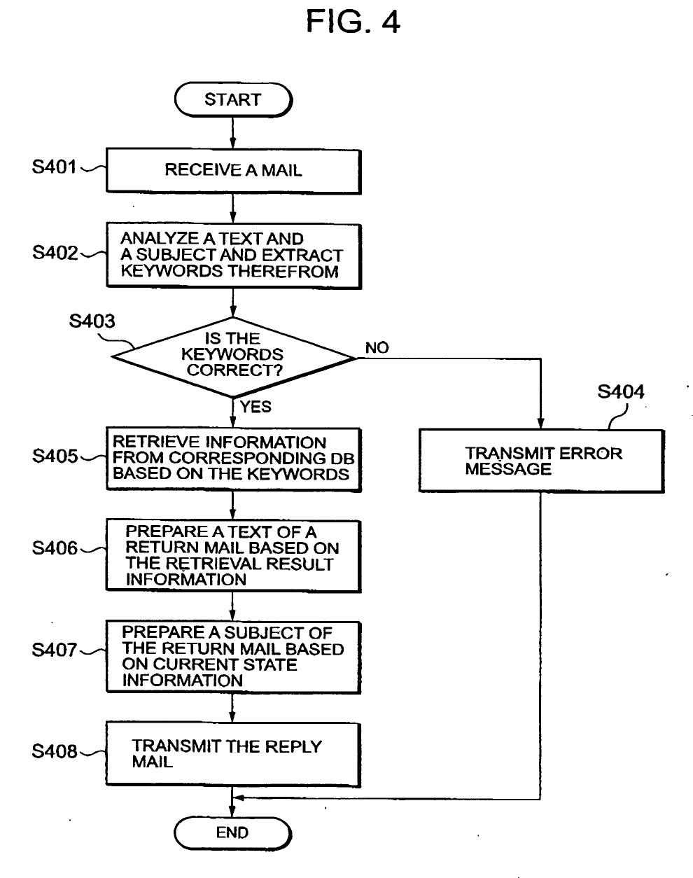

Next, a mail processing method will be described. First, as shown in FIG. 4, a mail from a user with the mobile phone 10 is transmitted to the mail server 20 through the packet communication network 40 and the Internet 41. The received mail from the user through the communication unit 21 of the mail server 20 is temporarily stored in the memory 22 (step S401). The storage of the received mail is performed for the purpose of extracting keywords and is temporary.

Next, the text and the subject (title) of the mail are analyzed by the keyword extracting unit, whereby the state information is read out and the keywords are extracted (step S402).

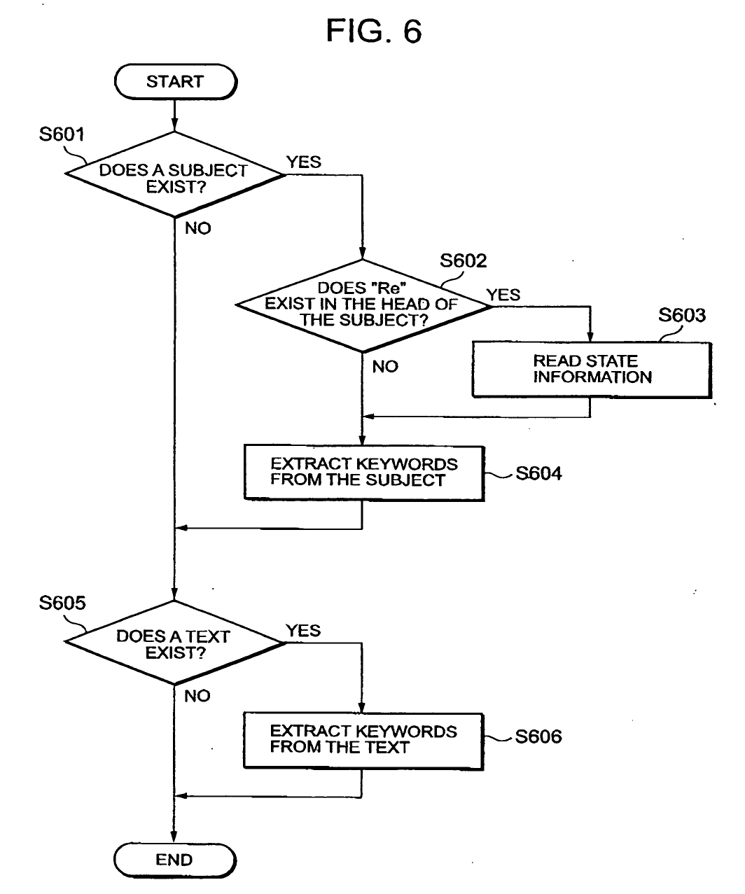

Details of the above-mentioned processes are described later with reference to FIG. 6.

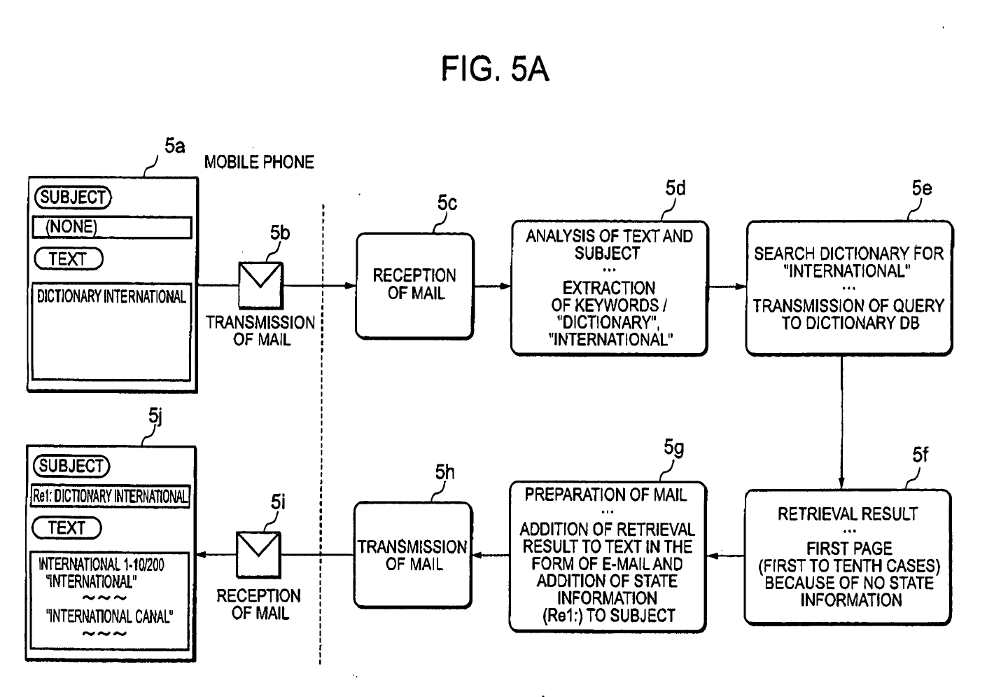

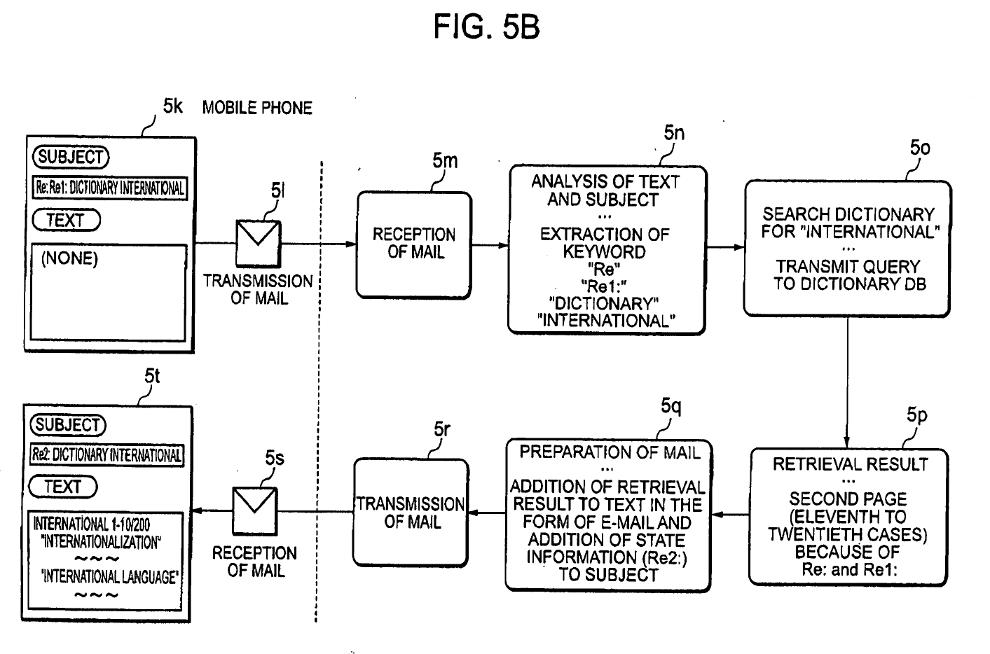

For example, as indicated by a reference numeral 5a in FIG. 5A, it is supposed that a mail in which the subject (title) 30a is empty and “DICTIONARY, INTERNATIONAL” is described in the text is transmitted from the user with the mobile phone 10 as indicated by a reference numeral 5b in FIG. 5A and is received through the communication unit 21 as indicated by a reference numeral 5c in FIG. 5A.

Here, contents of the subject (title) 30b is interpreted by the keyword extracting unit, contents of the text 30b is analyzed, and the keywords are extracted. Since the subject (title) 30a of the first mail is empty, “DICTIONARY, INTERNATIONAL” of the text 30b is analyzed.

By analyzing “DICTIONARY, INTERNATIONAL” of the text 30b, the keyword “DICTIONARY, INTERNATIONAL” is extracted as indicated by a reference numeral 5d in FIG. 5A.

Here, when the analysis is performed by the keyword extracting unit, it is checked whether the keyword is correct (step S403) , for example, depending upon existence of a keyword in the keyword extracting table 34. When it is checked that it is not correct, an error message requesting re-transmission is transmitted to the mobile phone 10 of the user (step S404).

An analysis rule may be included in the error message. The check whether the keyword is correct may be performed by a predetermined program including the content names or the addresses of the database.

When the keyword from the text 30b is correct, desired information is retrieved from any one of the dictionary DB 31, the story DB 32 and the game contents DB 33 of the corresponding database 30 by means of the execution unit using the keywords extracted by the keyword extracting unit as a query.

Here, the query includes an instruction of searching a dictionary for “INTERNATIONAL” as indicated by a reference numeral 5e in FIG. 5A. Then, details relating to the term “INTERNATIONAL” are retrieved from the dictionary DB 31. Since the subject (title) 30a in the first mail from the user is empty as indicated by the reference numeral 5a in FIG. 5A, no state information exists.

A first page including first to tenth cases of the details relating to the term “INTERNATIONAL” is retrieved in accordance with a predetermined rule and becomes the retrieval result information. The number of letters or the like of the first page can be properly set based on the specification of the respective communication carriers.

When a mail to be replied to the user with the mobile phone 10 is prepared by the reply mail generating unit based on the retrieval result information (step S406), the state information is inserted to, for example, the subject (title) 30a of the reply mail (step S407).

That is, as indicated by the reference numeral 5g in FIG. 5A, the state information of “(Re1: DICTIONARY, INTERNATIONAL)” is inserted to the subject (title) 30a based on the query so as to indicate the details relating to the first query “DICTIONARY” and “INTERNATIONAL”. “Re” in the head of the state information is a return symbol. The numeral portion “1” after the return symbol indicates the number of return and may be considered, for example, as an index for proceeding with a game. The “Re” is only an example and may be replaced with other letters or symbols.

Then, a mail in which the state information is inserted to the subject (title) 30a and the retrieval result information is included in the text is transmitted to the user with the mobile phone 10 (step S408). That is, when the mail in which the retrieval result information is described in the text 30b is transmitted to the user as indicated by a reference numeral 5h in FIG. 5A and the mail is received by the user as indicated by the reference numeral 5i in FIG. 5A, the state information of, for example, “(Re1: DICTIONARY, INTERNATIONAL)” is displayed in the subject (title) 30a in the screen of the mobile phone 10 as indicated by a reference numeral 5j in FIG. 5A and the first page including the first to tenth cases as details relating to the term “INTERNATIONAL” is displayed in the text 30b.

When the user prepares a reply mail, “(Re:)” is inserted to the subject (title) 30a of the received mail by the use of the function of the mobile phone 10 and “(Re: Re1: DICTIONARY INTENATIONAL)” is input to the subject (title) 30a as indicated by a reference numeral 5k in FIG. 5B. When the mail is transmitted to the mail server 20 as indicated by a reference numeral 51 in FIG. 5B and is received by a mail transmitting and receiving unit 21b as indicated by a reference numeral 5m in FIG. 5B, “Re: Re1: DICTIONARY INTENATIONAL” of the subject (title) 30a is analyzed by the keyword extracting unit as indicated by a reference numeral 5n in FIG. 5B and the keywords “Re:“, “Re1:“, “DICTIONARY”, and “INTERNATIONAL” are extracted therefrom as described above.

AS indicated by a reference numeral 5o in FIG. 5B, the query is interpreted as searching a dictionary for “INTERNATIONAL” and details relating to the term “INTERNATIONAL” is retrieved from the relevant dictionary DB 31.

Since it is checked by the keyword extracting unit that the current state information is “(Re: Re1: DICTIONARY INTENATIONAL)” as indicated by a reference numeral 5p in FIG. 5B, it means a retrieval request that “INTERNATIONAL” is retrieved from the page next to “Re1” and a second page including eleventh to twentieth cases of details relating to the term “INTERNATIONAL” is retrieved, which is obtained as the retrieval result information.

Since the retrieval result information is obtained and a mail to be replied to the user with the mobile phone 10 is prepared by the information retrieval execution unit 23, for example, the state information, “(Re2: DICTIONARY, INTERNATIONAL)”, is inserted to the subject (title) 30a of the reply mail as indicated by a reference numeral 5q in FIG. 5B and the reply mail is transmitted to the mobile phone 10 of the user as indicated by a reference numeral 5r in FIG. 5B.

When the reply mail is received as indicated by a reference numeral 5s in FIG. 5B, the state information of, for example, “(Re2: DICTIONARY, INTERNATIONAL)” is displayed in the subject (title) 30a in the screen of the mobile phone 10 as indicated by a reference numeral 5t in FIG. 5B and the second page including the eleventh to twentieth cases of the details relating to the term “INTERNATIONAL” is displayed in the text 30b.

Thereafter, the user can confirm the term “INTERNATIONAL” in the sense of searching a dictionary, by confirming the mail from the mail server 20 and replying the mail to the mail server 20.

Next, details of step S402 in FIG. 4 will be described with reference to FIG. 6. First, the keyword extracting unit checks whether the Subject (text) exists in the received mail (step S601) . When it is checked that the subject (text) exists, the keyword extracting unit checks whether “Re.” exists in the head of the subject (step S602).

When it is checked that “Re:” exists, the keyword extracting unit reads out the state information (step S603). In reading out the state information, it is interpreted that “Re:” of the subject “Re: Re2: DICTIONARY, INTERNATIONAL” is inserted at the time of preparing the reply mail to the mobile phone 10, that “Re2: DICTIONARY, INTERNATIONAL” is the original state information, and that it is a state “Re2:” of the keyword “DICTIONARY, INTERNATIONAL”.

When it is checked that “Re:” does not exist in the subject (No in step S602) or when the reading-out of the state information (step S603) is finished, the keywords are extracted from the subject (step S604). Since the present embodiment employs a rule of dividing the keywords by spaces, two keywords “DICTIONARY” and “INTERNATIONAL” are extracted from “DICTIONARY INTERNATIONAL”. However, the dividing of keywords is not limited to by spaces, but may be performed by “/”.

When it is checked that no content exists in the subject (No in step S601) or when the extracting of the keywords (step S6043) is finished, it is checked whether the text exists (step S605) When the text exists, the keywords are extracted from the text (step S606). In extracting the keywords from the text, when the text is analyzed in a unit of lines and, for example, a quotation mark “>” is attached to the head of an original sentence at the time of preparing a reply mail in the mobile phone 10, the line to which the quotation mark “>” is attached is neglected. Similar to the extracting of the keywords from the subject (step S604), when the rule of dividing-the keywords by spaces is employed, the respective keywords divided by spaces are extracted.

When it is checked that no text exists (No in step S605) or when the extracting of the keywords from the text (step S606) is finished, a series of steps are completed.

Next, the change of the screen of the mobile phone 10 accompanied with the information retrieval and delivery from each of the dictionary DB 31, the story DB 32, and the game contents DB 33 of the aforementioned database 30 will be described individually.

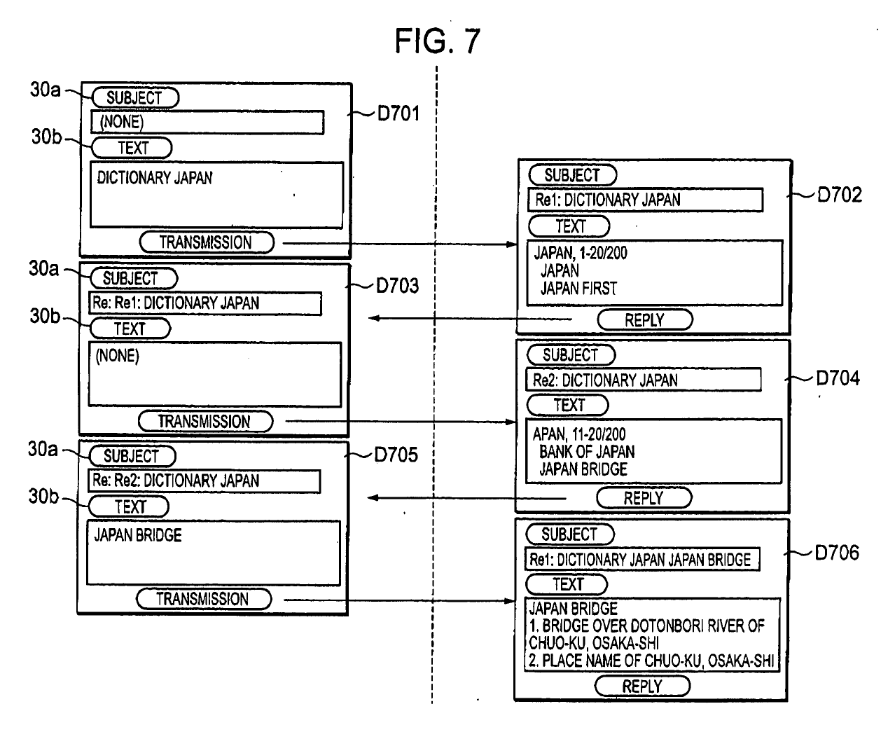

First, the change of the screen of the mobile phone 10 accompanied with the information retrieval and delivery from the dictionary DB 31 is described. As shown in FIG. 7, “DICTIONARY JAPAN” as retrieval keywords is input to the text in accordance with a predetermined rule in a mail preparation screen (the reference numeral D701 in FIG. 7). The predetermined rule for the retrieval keywords is arbitrary and can be set arbitrarily at the time of constructing a system.

Next, when a mail in which the retrieval keywords “DICTIONARY JAPAN” are input to the text and the subject (title) 30a is empty is transmitted to the mail server 20, the subject (title) 30a is interpreted and the text 30b is analyzed by the keyword extracting unit to extract the keywords. Here, since the subject (title) 30a of the first mail is empty, “DICTIONARY JAPAN” of the text 30b is analyzed.

Then, the keywords of “DICTIONARY” and “JAPAN” are extracted by the keyword extracting unit and details relating to the term “JAPAN” are retrieved from the dictionary DB 31 by the execution unit and are replied to the user. At this time, for example, a first page including first to tenth cases (among 200 pages) of the details relating to the term “JAPAN” is retrieved and replied to the user.

At this time, the state information “(Re1: DICTIONARY JAPAN)” included in the subject (title) 30a is displayed on the screen of the mobile phone 10 and the first page of the first to tenth cases is displayed as the details relating to the term “JAPAN” in the text 30b.

When the user prepares a reply mail, “(Re:)” is inserted to the subject (title) 30a of the received mail by the use of the function of the mobile phone 10 and “(Re: Re1: DICTIONARY JAPAN)” is input to the subject (title) 30a. When the mail is replied without any text (the reference numeral D703 in FIG. 7), the keyword extracting unit determines that the state information is, for example, “(Re: Re1: DICTIONARY JAPAN)”, which serves as a retrieval request of retrieving “JAPAN” from a page next to “Re1”.

Accordingly, a second page including eleventh to twentieth cases of details relating to the term “JAPAN” is retrieved and the retrieval result is replied to the user. At this time, the state information including, for example, “(Re2: DICTIONARY JAPAN)” in the subject (title) 30a is displayed on the screen of the mobile phone 10 and the second page including the eleventh to twentieth cases of details relating to the term “JAPAN” is displayed in the text 30b (the reference numeral D704 in FIG. 7).

When it is intended, for example, to know the meaning of “JAPAN BRIDGE”, a mail in which “JAPAN BRIDGE” is input to the text 30b is transmitted to the mail server 20 (the reference numeral D705 in FIG. 7) . Then, the state information including “(Re: Re2: DICTIONARY JAPAN)” in the subject (title) 30a is estimated by the keyword extracting unit of the information retrieval execution unit 23 and the text 30b is analyzed. As a result, the keyword “JAPAN BRIDGE” is extracted.

By using the keyword “JAPAN BRIDGE” extracted by the keyword extracting unit as a query, details relating to the term “JAPAN BRIDGE” are retrieved from the dictionary DB 31 and are replied to the user.

At this time, when the details relating to the term “JAPAN BRIDGE” are supposed to correspond to the first page including the first to tenth cases, the reply mail generating unit inserts the state information including “(Re1: DICTIONARY, JAPAN, JAPAN BRIDGE)” in the subject (title) 30a, whereby the state information including “(Re1: DICTIONARY, JAPAN, JAPAN BRIDGE)” in the subject (title) 30a is displayed on the screen of the mobile phone 10 and the details relating to the term “JAPAN BRIDGE” is displayed in the text 30b (the reference numeral D706 in FIG. 7).

In this way, the user can confirm the term “JAPAN BRIDGE” with the sense of directly searching a dictionary.

Since the state information including, for example, “(Re1: DICTIONARY, JAPAN)” is displayed in the subject (title) 30a on the screen of the mobile phone 10, the user can easily grasp the current page by confirming the state information.

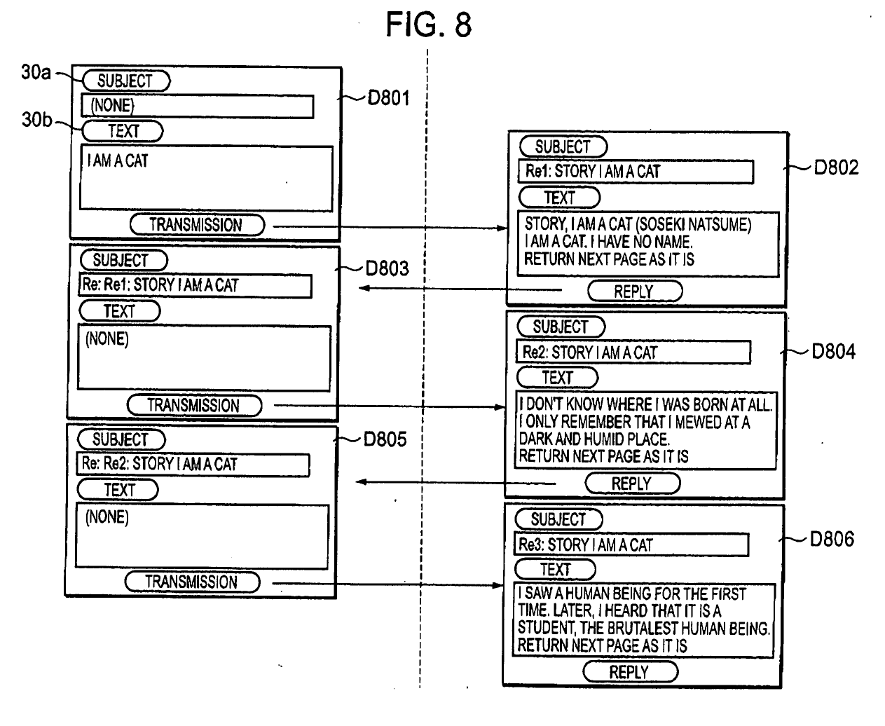

Next, the change of the screen of the mobile phone 10 accompanied with the information retrieval and delivery from the story DB 32 will be described. First, as shown in FIG. 8, “STORY, I AM A CAT” which is a retrieval keyword is input to the text on the mail preparing screen in accordance with a predetermined rule (the reference numeral D801 in FIG. 8). The predetermined rule for the retrieval keyword is arbitrary and can be set arbitrary at the time of constructing a system.

Next, when the retrieval keyword “STORY, I AM A CATS” is input to the text 30b and the mail in which the subject (title) 30a is empty is transmitted to the mail server 20, the keyword extracting unit checks the subject (title) 30a and analyzes the text 30b, thereby extracting keywords. However, since the subject (title) 30a of the first mail is empty, “STORY, I AM A CAT” in the text is analyzed.

Then, the keywords “STORY” and “I AM A CAT” are extracted by the keyword extracting unit and a first page of the story “I AM A CAT” is retrieved from the story DB 32 and replied to the user. The number of letters displayed in the first page can be set properly in accordance with the specification of the respective communication carriers.

At this time, the state information including, for example, “(Re1: STORY, I AM A CAT)” in the subject (title) 30a is displayed on the screen of the mobile phone 10 and the first page of the story “I AM A CAT” is displayed in the text 30b (the reference numeral D802 in FIG. 8).

Here, when the user reads the first page and replies the mail without any text (the reference numeral D803 in FIG. 8), it is checked by the keyword extracting unit of the information retrieval execution unit 23 that the current state information is “(Re: Re1: STORY, I AM A CAT)” and a second page of the story “I AM A CAT” is retrieved and replied to the user.

At this time, the state information including, for example, “(Re2: STORY, I AM A CAT)” in the subject (title) 30a is displayed on the screen of the mobile phone 10 and the second page of the story “I AM A CAT” is displayed in the text 30b (the reference numeral D804 in FIG. 8).

Here, when the user reads the second page and replies the mail without any text (the reference numeral D805 in FIG. 8), it is checked by the keyword extracting unit that the current state information is “(Re: Re2: STORY, I AM A CAT)” and a third page of the story “I AM A CAT” is retrieved and replied to the user.

At this time, the state information including, for example, “(Re3: STORY, I AM A CAT)” in the subject (title) 30a is displayed on the screen of the mobile phone 10 and the third page of the story “I AM A CAT” is displayed in the text 30b (the reference numeral D806 in FIG. 8).

Thereafter, whenever the user reads the third page and replies the mail without any text, the current state information is checked by the keyword extracting unit and the corresponding page is retrieved and replied to the user.

In this way, the user can directly read the story, only by simply transmitting a reply mail to the mail server 20. In addition, since the state information including, for example, (Re1: STORY, I AM A CAT)” is displayed in the subject (title) 30a on the screen of the mobile phone 10, the user can easily grasp the current page by checking the state information.

Next, the change of the screen of the mobile phone 10 accompanied with the information retrieval and delivery from the game contents D5 33 will be described. In the following description, the state information in the subject (title) 30a of the mail indicates a scene of a game, but the state information may be encoded for the purpose of prevention of illegal manipulation by the user.

In encoding the state information, the reply mail generating unit may execute the encoding by the use of a predetermined encoding program. Similarly, the reply mail generating unit may execute the decoding of the encoded state information by the use of a predetermined decoding program.

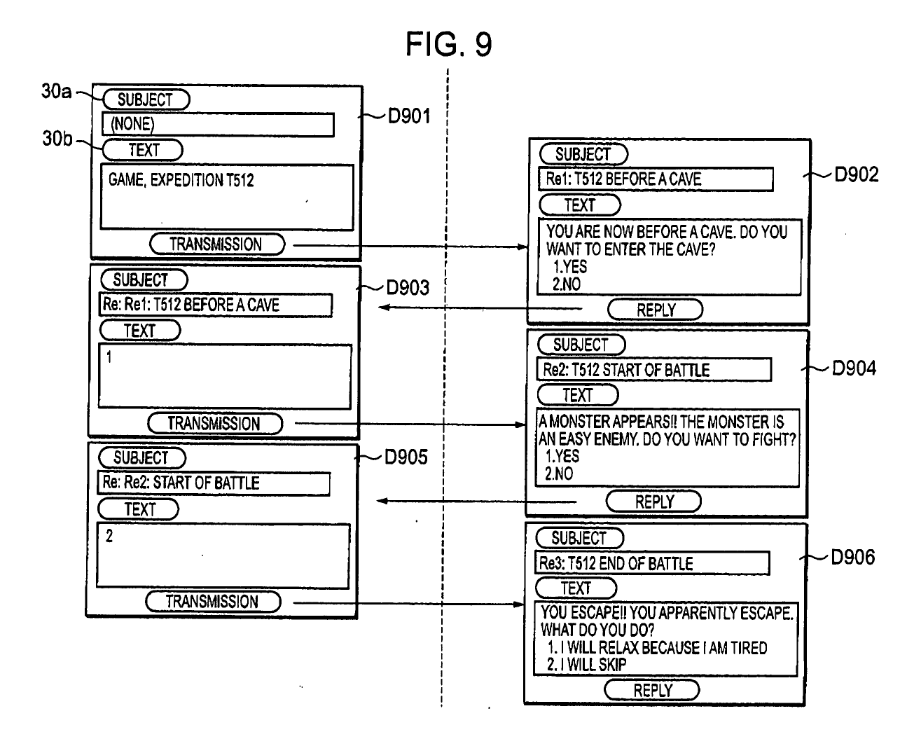

First, as shown in FIG. 9, “GAME, EXPEDITION T512” which is a retrieval keyword is input to the text 30b on the mail preparation screen in accordance with a predetermined rule (the reference numeral D901 in FIG. 9). “T512” may be a number indicating an identifier of the game. The predetermined rule for the retrieval keyword is arbitrary and can be set arbitrarily at the time of constructing a system.

Next, when the retrieval keyword “GAME, EXPEDITION T512” is input to the text 30b and then a mail in which the subject (title) 30a is empty is transmitted to the mail server 20, the keyword extracting unit checks the subject (title) 30a and analyzes the text 30b, thereby extracting the keywords. However, since the subject (title) 30a of the first mail is empty, “GAME, EXPEDITION T512” of the text 30b is analyzed.

Then, the keywords “GAME” and “EXPEDITION T512” are extracted by the keyword extracting unit and a scene of the game “EXPEDITION T512” is retrieved from the game contents DB 33 and replied to the user by the execution unit. The number of letters displayed for each scene may be set properly in accordance with the specification of the respective communication carriers.

At this time, the state information including “(Re1: T512, BEFORE A CAVE)” in the subject (title) 30a is displayed on the screen of the mobile phone 10 and the corresponding scene of the game “EXPEDITION T512” is displayed in the text 30b (the reference numeral D902 in FIG. 9).

When the user inputs “1” in indicating “Yes” to the text 30b as a response to a question “YOU ARE NOW BEFORE A CAVE. DO YOU WANT TO GO IN THE CAVE?”, which is a scene of the mail, and replies the mail (the reference numeral D903 in FIG. 9), the keyword “1” indicating “Yes” is extracted by the keyword extracting unit and it is checked that the current state information is “(Re: Re1: T512, BEFORE A CAVE).”

Then, a next scene of the game −EXPEDITION T512” is retrieved and replied to the user, similarly.

At this time, the state information including “(Re2: T512, START OF BATTLE)” in the subject (title) 30a is displayed on the screen of the mobile phone 10 and the next scene of the game “EXPEDITION T512” is displayed in the text 30b (the reference numeral D904 in FIG. 9).

When the user inputs “2” indicating “No” to the text 30b as a response to a question “A MONSTER APPEARS!! THE MONSTER IS AN “EASY ENEMY”. DO YOU WANT TO FIGHT?”, which is the next scene of the mail, and replies the mail (the reference numeral D90S in FIG. 9), the keyword “2” indicating “No” is extracted by the keyword extracting unit and it is checked that the current state information is “(Re: Re2: T512, START OF BATTLE).”

Then, another next scene of the game “EXPEDITION T512” is retrieved and replied to the user, similarly.

At this time, the state information including “(Re3: T512, END OF BATTLE)” in the subject (title) 30a is displayed on the screen of the mobile phone 10 and another next scene of the game “EXPEDITION T512” is displayed in the text 30b (the reference numeral D906 in FIG. 9).

When the user inputs any one of “1. I WILL RELAX BECAUSE I AM TIRED.” and “2. I WILL SKIP” to the text 30b as a response to a question “YOU ESCAPE!! YOU APPARENTLY ESCAPE, WHAT DO YOU DO?”, which is another next scene of the mail, and replies the mail, still another scene of the game “EXPEDITION T512” is retrieved and replied to the user.

Thereafter, whenever a numeral indicating a response for each scene is input and replied, the current state information is checked by the keyword extracting unit and a next scene is retrieved and replied to the user.

In this way, the user can enjoy a game only by transmitting a reply mail to the mail server 20. In addition, since the state information such as “(Re1: T512, BEFORE A CAVE)”—“(Re1: T512, END OF BATTLE)” is displayed in the subject (title) 30a on the screen of the mobile phone 10, it is possible to easily grasp the name of game and the respective scenes of the game “EXPEDITION T512.”

In addition, by encoding a part of the state information, it is possible to prevent illegal access when the game contents is paid transmission.

In the present embodiment, the corresponding information is retrieved from any one of the dictionary DB 31, the story DB 32, the game contents DB 33 of the database 30 in which information on the information retrieval request is registered based on the state information in response to the current information retrieval request from the mobile phone 10, the mail including the retrieval result information and the state information on the retrieval result information is transmitted to the mobile phone 10, and the next information retrieval is executed based on the state information included in a reply mail when the reply mail is replied from the mobile phone 10.

As a result, since it is not necessary to retain the state information indicating the states of the information retrieval request from the user in a dedicated database or files of the server in mass and the server resources can be utilized more efficiently, it is possible to construct a system at low cost.

That is, since it is not necessary to retain the state information in the dedicated database or files of the mail server 20 according to the embodiments, it is not necessary to prepare the server resources corresponding to the number of users even when the number of users to use the information retrieval and delivery service in the form of E-mail increases. As a result, it is possible to construct a system at low cost

In the present embodiment, the mail in which the retrieval result information on the information retrieval request in the form of E-mail from the mobile phone 10 and the state information on the retrieval result information have been described is replied to the mobile phone 10. Accordingly, since it is only necessary to confirm the state information for the reply mail from the mobile phone 10, the user can see more specific information with a simple manipulation and the server can remove the restriction on contents from the information retrieval and delivery.

The present invention can apply to general communication systems using a client having a mail function

In the mail processing server, the mail processing method, and the mail processing program according to the present invention described above, the mail received from the client are stored, the keywords are extracted from the received mail, the query is estimated based on the keywords, the process corresponding to the query is performed, the query is inserted to the title of the reply mail, the text of the reply mail is generated by the use of the execution result of the process, and the reply mail is delivered to the client. As a result, since it is not necessary to retain the state information indicating the state of the information retrieval request from the users in a dedicated database or files of the server in mass and the server resources can be more efficiently utilized, it is possible to construct a system at low cost.

What is claimed is:

1. A mail processing server for transmitting to and receiving from a client a mail, the mail processing server comprising:
a memory unit for storing the received mail from the client;
a keyword extracting unit for extracting keywords from the received mail stored in said memory unit;
an execution unit for interpreting a query based on the keywords extracted by said keyword extracting unit and executing a process corresponding to said query;
a reply mail generating units for inserting said query to the title of a reply mail and generating a text of said reply mail by the use of the execution result of said execution unit; and
a mail replying unit for replying the reply mail generated by said reply mail generating unit to said client which serves as a transmission source.

2. The mail processing server according to claim 1, wherein said execution unit executes a dictionary search and acquires a meaning of a term as the execution result

3. The mail processing server according to claim 1, wherein said execution unit executes a game processing and acquires a selected branch for proceeding with a game as the execution result.

4. The mail processing server according to claim 1, wherein said execution unit checks existence of a return symbol in the keyword corresponding to the title of the received mail among the keywords extracted by said keyword extracting unit and executes the process corresponding to said query by using the return symbol as an index when it is checked that said return symbol exists.

5. The mail processing server according to claim 4, wherein said return symbol includes a numeral and indicates a different index corresponding to said numeral.

6. A mail processing method of a server that transmits to and receives from a client a mail, the method comprising:
storing a received mail from said client in a memory provided in said server;
extracting keywords from the received mail stored in said memory;
interpreting a query based on said keywords extracted and executing a process corresponding to said query;
inserting said query to the title of a reply mail and generating a text of said reply mail by the use of said execution result ; and
replying said reply mail generated to said client which is a transmission source.

7. The mail processing method according to claim 6, wherein said executing of the process includes executing a dictionary search and acquiring a meaning of a term as the execution result.

8. The mail processing method according to claim 6, wherein said executing of the process includes executing a game processing and acquiring a selected branch for proceeding with a game as the execution result.

9. The mail processing method according to claim 6, wherein said executing of the process includes checking existence of a return symbol in said keyword corresponding to the title of said received mail among said keywords extracted by said keyword extracting means and executing the process corresponding to said query by using said return symbol as an index when it is checked that the return symbol exists.

10. A mail processing program which can be executed in a computer of a server that transmits to and receives from a client a mail, the mail processing program allowing the computer to execute:
storing a received mail from said client in a memory provided in said server;
extracting keywords from said received mail stored in said memory;
interpreting a query based on said keywords extracted and executing a process corresponding to said query;
inserting said query to the title of a reply mail and generating a text of said reply mail by the use of the execution result; and
replying said reply mail generated to said client which is a transmission source.

11. The mail processing program according to claim 10, wherein said executing of the process includes executing a dictionary search and acquiring a meaning of a term as the execution result.

12. The mail processing program according to claim 10, wherein said executing of the process includes executing a game processing and acquiring a selected branch for proceeding with a game as the execution result.

13. The mail processing program according to claim 10, wherein said executing of the process includes checking existence of a return symbol in the keyword corresponding to the title of said received mail among said keywords extracted by said keyword extracting means and executing the process corresponding to said query by using said return symbol as an index when it is checked that the return symbol exists.
